(19) United States
(12) Patent Application Publication
(10) Pub. No.: US 2026/0120463 A1
(43) Pub. Date: Apr. 30, 2026

(54) MACHINE LEARNING FOR REAL TIME HIGHLIGHT DETECTION IN HIGH RESOLUTION VIDEOS

(71) Applicant: Baller, Inc., Pasadena, CA (US)

(72) Inventors: Yoav Liberman, Dublin (IE); Paul Georg Kefer, Pasadena, CA (US); Paul Renfrew, Port Charlotte, FL (US); Brian James Vernarsky, San Francisco, CA (US)

(21) Appl. No.: 18/927,333

(22) Filed: Oct. 25, 2024

(51) Int. Cl. G06V 20/40; G06T 7/20; G06T 7/70; G06V 10/25; G06V 10/77; G06V 10/82; G06V 40/10; G06V 40/20

(52) U.S. Cl. CPC G06V 20/42; G06T 7/20; G06T 7/70; G06V 10/25; G06V 10/7715; G06V 10/82; G06V 40/10; G06V 40/20; G06T 2207/10016; G06T 2207/20084; G06T 2207/30196; G06T 2207/30224

(57) ABSTRACT

A system or a method uses machine learning models to generate highlight videos for a sports event. The system accesses a ball classifier, a human classifier, and a set of highlight classifiers. The ball classifier identifies and tracks a ball's location within the video, the human classifier generates bounding boxes around players, and the set of highlight classifiers detects specific human actions based on the interactions between the players and the ball. When a significant change in the ball's speed or direction is detected, the system identifies player movements near the ball during that time and applies the highlight classifiers to determine if any actions occurred. A highlight video is generated by combining frames where the detected actions take place.

### TECHNICAL FIELD

This disclosure relates generally to video processing, more specifically to using machine-learning to process high-resolution videos in near real time.

### BACKGROUND

Object identification in images is an important task in computer vision. For example, in healthcare, object identification can be used to detect tumors, anomalies, or specific organs in medical scans like X-rays or MRIs. Robots can identify objects in their environment, such as tools, packages, or materials, to perform tasks like sorting or picking. As another example, security checkpoints may employ object identification to detect concealed or prohibited items.

In some cases, the goal is not only to identify what is present in a single image but also to track objects in a video. A video is a sequence of images (referred to as frames) displayed in rapid succession to create the illusion of motion. Each frame captures a moment in time, and when played back rapidly (e.g., at greater than 24 frames per second), the human eye perceives fluid movement.

However, identifying objects in a video stream in real time poses significant challenges. For instance, in sports, where players and balls move at high speeds, tracking these objects in real time can be particularly difficult due to the rapid motion and frequent changes in position. This becomes even more difficult with high-resolution videos, such as 4K (3840×2160) or 8K, which contain far more pixels per frame than standard resolution videos. The larger file sizes and increased data per frame slow down processing speeds, as object identification algorithms often analyze every pixel. With millions of pixels per frame and high frame rates (e.g., 60 fps or higher), the computational demands become immense. Handling this amount of data in real-time, particularly in fast-paced videos like sports, is exceedingly difficult.

### SUMMARY

Embodiments described herein relate to a method or system that uses machine learning to achieve real time or near real time highlight detection in high resolution videos, such as sports videos.

In some embodiments, a system accesses a ball classifier, a human classifier, and a set of highlight classifiers. The ball classifier is configured to identify the location of a ball within a video frame and track the ball's movement across a set of video frames during a sports event. The human classifier is configured to generate bounding boxes around humans within video frames during the sports event. Each highlight classifier is configured to identify a corresponding action of a person within the video frames of the sports event. The system captures video of the sports event and applies the ball classifier and the human classifier to the captured video. When applied, the ball classifier determines the movement of the ball within the captured video, and the human classifier generates bounding boxes around humans in the captured video.

The system also identifies, based on the determined movement of the ball, times within the captured video when a change in the ball's direction or speed exceeds a threshold. For each identified time, the system identifies a set of bounding boxes within a threshold distance from the ball's location in the video frames and within a threshold time of the identified time. It then applies the set of highlight classifiers to the identified set of bounding boxes to determine if any of the humans within the bounding boxes perform the actions corresponding to the set of highlight classifiers. The system generates a highlight video by combining sets of video frames determined to include humans performing actions corresponding to the highlight classifiers.

### BRIEF DESCRIPTION OF DRAWINGS

The figures use like reference numerals to identify like elements. A letter after a reference numeral, such as “104A,” indicates that the text refers specifically to the element having that particular reference numeral. A reference numeral in the text without a following letter, such as “104,” refers to any or all of the elements in the figures bearing that reference numeral.

FIG. 1 illustrates an example system environment for a streaming service with an image processing module that receives and processes video captured at a sports event, according to one or more embodiments.

FIG. 2 illustrates an example system architecture for an image processing module, in accordance with one or more embodiments.

FIG. 3 illustrates an example machine learning network trained to detect actions using a combination of convolutional, residual, and fully connected layers, in accordance with one or more embodiments.

FIG. 4 illustrates an example architecture of a residual block which is a part of a machine learning network for detecting actions in accordance with one or more embodiments.

FIGS. 5A-5D illustrate examples of sports actions detection by the image processing module in accordance with one or more embodiments.

FIG. 6 illustrates a flowchart of a method for sports action identification in accordance with one or more embodiments.

FIG. 7 is a flowchart of a method for generating highlight videos for a sports event in accordance with one or more embodiments.

FIG. 8 is a block diagram of an example computer suitable for use in the networked computing environment of FIG. 1.

The figures depict various embodiments for purposes of illustration only. One skilled in the art will readily recognize from the following description that alternative embodiments of the structures and methods illustrated herein may be employed without departing from the principles of the disclosure described herein.

### DETAILED DESCRIPTION

A video includes a sequence of images (frames) displayed rapidly to create the illusion of motion. Object identification in videos is an important task in computer vision, which involves detecting and recognizing objects (e.g., people, balls, vehicles) across multiple frames, enabling the tracking of movement and behavior over time. For instance, in sports, object identification helps track players and key events during live matches. Similarly, autonomous vehicles use this technology to detect pedestrians, stop signs, and traffic signals to navigate safely. However, high-resolution videos (e.g., 4K or 8K) contain significantly more pixels per frame, resulting in larger file sizes and higher computational demands. Processing these millions of pixels in real-time, especially at high frame rates, poses significant challenges for both computer hardware and software.

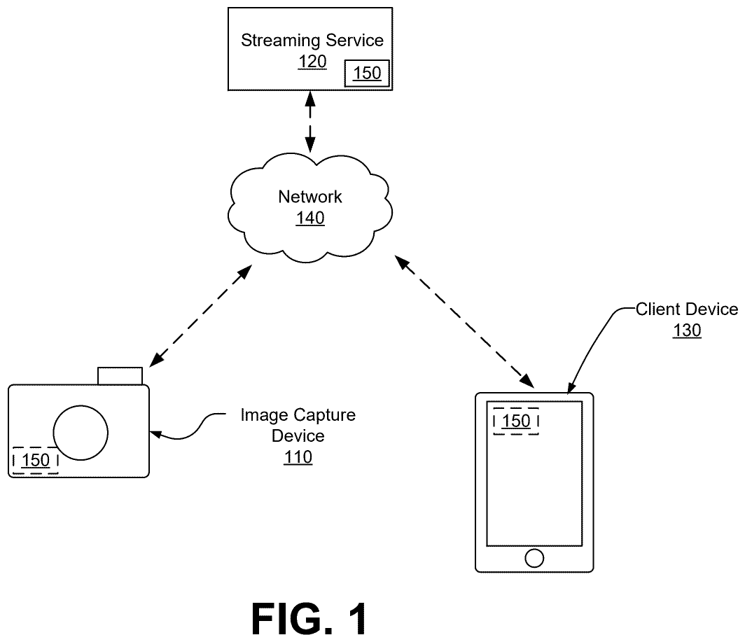

The embodiments described herein address the above-described problem through a novel machine learning system and/or method, implementing an improved architecture and a new loss function, enabling efficient training while maintaining accuracy on large-scale data. The system is capable of performing real-time or near real-time inference on high-resolution video streams with high accuracy. Additional details about the system and method are described below with respect to FIGS. 1-7.

### System Environment for Image Processing Module

FIG. 1 illustrates an example system environment for a streaming service 120, according to one or more embodiments. The system environment illustrated in FIG. 1 includes an image capture device 110, a client device 130, a streaming service 120, and a network 140. Alternative embodiments may include more, fewer, or different components from those illustrated in FIG. 1, and the functionality of each component may be divided between the components differently from the description below. For example, the functionality or a portion of the functionality described below as being performed by the streaming service 120 may be performed by the client device 130. Additionally, each component may perform their respective functionalities in response to a request from a human, or automatically without human intervention.

The image capture device 110 captures imaging data of an area surrounding a user of the image capture device. The image capture device 110 may be one of various types of devices including, but not limited to, digital cameras, smart phones, tablets, drones, or any other suitable device configured to capture an image. The image capture device 110 may be equipped with various types of sensors to capture different types of image data, for example still photographs, video, infrared images, or three-dimensional (3D) images. Examples of such sensors include, but are not limited to, charge-coupled devices (CCDs) and complementary metal-oxide semiconductor (CMOS) sensors. The image capture device 110 typically includes one or more optical elements, for example lenses, image sensors, image signal processing sensors, encoders, or a combination thereof to capture and process image data. The optical elements of the image capture device 110 capture images by receiving and focusing light. The image capture device 110 further includes a controller that processes and transmits image data collected by the image capture device 110.

The image capture device 110 includes a camera configured to capture image and/or video data (e.g., video frames). The camera may be configured to capture high-resolution images or video footage (e.g., 4K or 8K) with high speed. For example, the image capture device 110 may be a device used at a sports event. Sports often involve fast-moving action, so in some embodiments, the image capture device 110 is capable of high frame rate (e.g., 60 fps, 120 fps, or even higher) to capture smooth, blur-free motion. For live sports broadcasting or streaming, the captured footage needs to be transmitted in real-time to broadcasting or streaming services 120. Accordingly, in some embodiments, the image capture device 110 may also include network interfaces capable of real-time data transfer, through wireless or wired connections. In some embodiments, there may be multiple image capture devices 110 positioned around a venue to cover various angles of actions. These image capture devices 110 work together to offer dynamic and comprehensive coverage, allowing a broadcasting or streaming service 120 to switch between angles and replay crucial moments from different perspectives.

In some embodiments, the image capture device 110 transmits the captured images to the streaming service 120 for further image processing. The streaming service 120 may include an image processing module 150 configured to process images in real time or near real time. Alternatively, the image processing module 150 may be deployed on the image capture device 110, allowing the device to process video frames before transmitting them to the streaming service 120. In another embodiment, the image processing module 150 may be deployed on the client device 130, where it processes the streaming data as it is received, before the data is displayed.

The image processing module 150 may perform various image processing techniques, for example applying filters, enhancing image quality, resizing images, compressing images, or adding metadata to the captured image data before transmitting the processed image data to the client device 130. In some embodiments, the image processing module 150 may also apply various machine learning models to the received video frames. The machine learning models are trained to detect objects in each video frame, track those objects across multiple frames, and identify actions based on the tracked objects' movement. For instance, in a ball game, the models can detect and track a ball and players, and identify actions such as spikes in volleyball, goals in soccer, or slam dunks in basketball.

In some embodiments, the image processing module 150 is also configured to annotate players or balls associated with specific actions and overlay these annotations on the video frames. For instance, the image processing module 150 may identify that Player 24 is performing a pass, and both Player 24 and the event “pass” can be overlaid on the frame. Additionally, or alternatively, the identified player (e.g., Player 24) may be annotated with a bounding box, while the movement direction of the ball being passed could be represented by an arrow overlaid on the frame.

The streaming service 120 may then stream the processed video frames, e.g., the video frames overlayed with annotations about identified actions. In some embodiments, the image processing module 150 is also configured to generate highlight for the identified actions, and the streaming service 120 can replay the highlight in normal speed or slow motion.

The client device 130 is a computing device that can access the video frames streamed by the streaming service 120. The client device 130 can display image data captured by the image capture device 110 after processing by the image processing module 150. Accordingly, a user can view image data collected by the image capture device 110 and processed by the image processing module 150 via the client device 130. The client device 130 can be a personal or mobile computing device, such as a television, a smartphone, a tablet, a laptop computer, or a desktop computer. In one or more embodiments, the client device 130 executes a client application that uses an application programming interface (API) to communicate with the streaming service 120 through the network 140.

The image capture device 110 and the client device 130 can communicate with the streaming service 120 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, 5G spectra, LTE-M), or satellites. The network 140 also may use networking protocols, such as TCP/IP, HTTP, SSH, SMS, or FTP, to transmit data between computing devices. In one or more embodiments, the network 140 may include Bluetooth or near-field communication (NFC) technologies or protocols for local communications between computing devices. The network 140 may transmit encrypted or unencrypted data.

### Example Image Processing Module

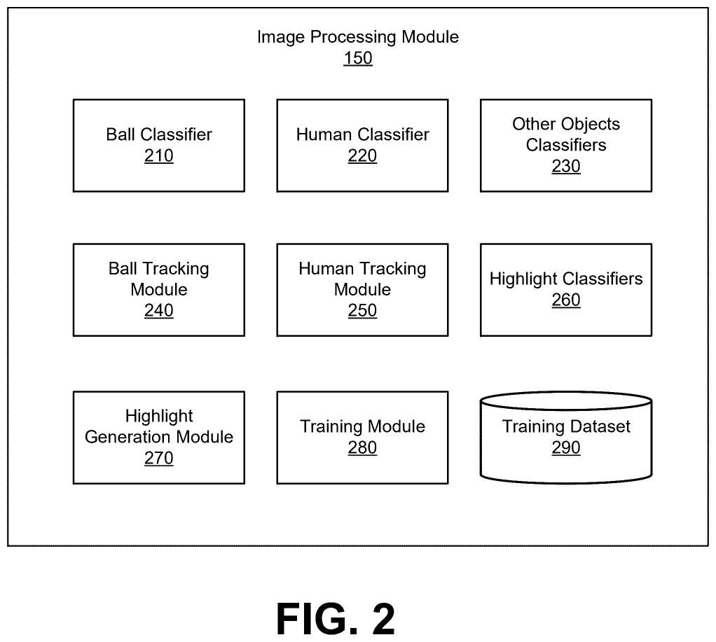

FIG. 2 illustrates an example system architecture for an image processing module 150, in accordance with one or more embodiments. The image processing module includes a ball classifier 210, a human classifier 220, other objects classifiers 230, a ball tracking module 240, a human tracking module 250, one or more highlight classifiers 260, a highlight generation module 270, a training module 280, and a training dataset 290. In some embodiments, the image processing module 150 may include more or fewer components as shown in FIG. 2. In some embodiments, the functions of one module may be partially or completely carried out by another module. In some embodiments, multiple modules may be combined into a single module.

The ball classifier 210 is a machine-learning model trained to detect balls each frame of a video, such as basketballs, soccer balls, volleyballs), depending on the application. In some embodiments, the ball classifier 210 may be trained on labeled images containing labeled balls. The training dataset may include positive examples which are images with balls and negative examples which are images without balls. For example, for a soccer ball classifier, each positive example includes an image with a soccer ball. These positive example may be taken from different perspective, in various lighting conditions, and with different backgrounds. Each negative example does not contain a soccer ball, but may include other objects (e.g., players, equipment, grass, backgrounds), which help the model learn to distinguish the ball from non-ball objects. Each labeled image may include a bounding box drawn around a ball, and the bounding box may be annotated with coordinates for the ball's position.

The ball classifier 210 may be trained over convolutional neural networks (CNNs), YOLO (You Only Look Once), fast R-CNN (Region-based CNN), and/or SDD (Single Shot Multibox Detector). The ball classifier 210 may also be trained from a pretrained model, such as ResNet, VGGNet or MobileNet, which have already been trained on large datasets like ImageNet. By using transfer learning, these networks are fine-tuned to specifically classify the ball in the training dataset. Different type of balls may correspond to a different ball classifier 210. For example, separate ball classifiers 210 may be separately trained for soccer ball, basketball, tennis ball, hockey puck, among others.

The human classifier 220 is another machine-learning model trained to identify humans within each frame of a video. For example, the human classifier 220 may be trained to identify individual players on a sports field, while distinguishing players from other objects or backgrounds. Similar to the ball classifier 210, the human classifier 220 may also be trained over images labeled with or without persons. In some embodiments, the human classifier 220 may also be trained to differentiate members in different teams and identify specific players in each team. For example, the human classifier 220 may be trained not only to detect humans but also to recognize key attributes such as team affiliations (e.g., based on uniform color) and player identification (e.g., based on jersey numbers).

In some embodiments, the human classifier 220 may also include a pose estimation model. The pose estimation model is a machine-learning model trained to detect positions of certain points on a human body to estimate the body's overall posture or pose. These points (also referred to as landmarks) on a human body may include joints (e.g., head, shoulders, elbows, knees, wrists, hips, ankles). These key points may be used to reconstruct the body's configuration and orientation in an image or video frame. In some embodiments, the pose estimation model may be a 2D pose estimation model. The key points are detected on a 2D plane. Each key point corresponds to an (x, y) coordinate, e.g., a pixel location of the joint in the image. The 2D pose estimation model connects these key points with lines to form a skeleton model of the person's body. This skeleton indicates the person's posture and movement direction. For example, in sports, the 2D pose estimation model could track how an athlete's limbs move during a specific action, such as running, jumping, or throwing. In some embodiments, the pose estimation model is a 3D pose estimation model, which extends 2D pose estimation by adding a third z-coordinate, which provides information about depth or how far each point is from the camera. This enables more accurate representation of body poses in three-dimensional space.

The other objects classifier(s) 230 are machine-learning models trained to identify other objects that are important for understanding the dynamics of a sports game or event. These object classifiers 230 may also be trained over images labeled with or without the corresponding objects. These objects may include goalposts, nets, and baskets. For sports like soccer, basketball, hockey, or tennis, detecting goal posts, nets, or baskets is important for analyzing actions like scoring a goal or making a basket. In addition, these object may further include lines and boundaries of sports fields. In many sports, identifying the lines and boundaries (e.g., in soccer, tennis, or football fields) is important for determining when a player or ball goes out of bounds. This classifier could track whether the ball or players are inside or outside the player area.

The ball tracking module 240 operates in conjunction with the ball classifier 210. The ball tracking module 240 configured to track position and movement of a ball (identified by the ball classifier 210) across multiple frames in a video. In some embodiments, after the ball is detected in a first frame, the ball tracking module 240 use a time series data structure to track positions of the ball across video frames. For example, a position of the ball may be recorded as two dimensional coordinate (e.g., x, y coordinates) on each frame. Each video frame may be represented as a 2D grid of pixels, where the (x, y) coordinates define a specific location within this grid.

In some embodiments, once a ball is detected, a bounding box is generated around the detected ball. The coordinates of the ball can be determined based on a center point of the bounding box. For each frame in the video, after detecting the ball's position, its (x, y) coordinates are recorded. The position of the ball is tracked across multiple frames, creating a time series of positions. For instance, at frame t, the ball might be at (xₜ, yₜ), and at frame t+1, the ball could be at (xₜ₊₁, yₜ₊₁). This sequence of positions allows the tracking of the ball's movement over time. In some embodiments, the ball tracking model 240 is a 3D model that tracks a ball's position in three-dimensional space. In such embodiments, the coordinates of the ball may be represented as (x, y, z), where z-coordinate provides depth information, indicating a distance from the camera.

In some embodiments, the ball tracking module 240 determines and tracks a ball's movement direction as a vector by computing a change in the ball's (x, y) position over consecutive video frames. In some embodiments, the vector represents both the direction and magnitude (speed) of the ball's movement. As such, the ball tracking module 240 may also be able to predict the ball's movement in a next frame or next a few frames. If the ball's movement changes abruptly (e.g., a bounce off a surface or being hit or kicked by a player), the vector will reflect this sudden change in direction and/or speed. In sports like soccer, basketball, or tennis, tracking the ball's movement as a vector over time can help analyze its trajectory, speed, and direction. This analysis can then be used to determine whether a specific action has taken place (e.g., by tracking if the ball is moving toward a goal or net and identifying a nearby athlete who may have interacted with the ball to perform that action).

The human tracking module 250 is configured to track positions of people identified by the human classifier in multiple frames of a video. Similar to the ball tracking module 240, the human tracking module 240 can track a human's positions and movements as vectors in a similar way. In some embodiments, the human tracking module 240 further accounts for additional complexities related to human movement dynamics. In some embodiments, each person's position is represented in (x, y) coordinates with each frame. For tracking humans, more advanced techniques may be used to account for posture, body orientation, and movement patterns. Once a person is detected by the human classifier 220, a bounding box is generated around the detected person. The human tracking module 250 may identify a reference point such as a center of mass or key points like a head or torso, and using coordinates of the reference point as a position of the person.

In some embodiments, the human tracking module 250 may also track a person's pose. As described above, the human classifier 220 may include a pose estimator configured to estimate a person's pose based on positions of points (e.g., head, joints) of a human body. The human tracking module 250 can analyze changes in the person's pose over time to identify specific movements. For example, in volleyball, a person raising their arm above their head could indicate a spike, bending down with a straight back might indicate a defensive stance, diving or lunging forward might indicate a save.

The highlight classifiers 260 is configured to identify actions in sports based on tracked motion of players and the ball. In some embodiments, the highlight classifiers 260 includes another machine learning model configured to receive motion of the ball from the ball tracking module 240 and motion of players from the human tracking module 250 as input and identifies an action based on these input. In some embodiments, the highlight classifiers 260 may analyze trajectory of the ball. For example, a ball moving toward a goal could signal a shot attempt. The highlight classifiers 260 may also analyze how close a player is to the ball over time. If the player is close to the ball and the ball's movement correlates with the player's trajectory, this could indicate actions like passing, dribbling, shooting, or controlling the ball. When the ball changes direction or speed after coming near a player, it may signal an interaction (e.g., a player kicking or intercepting the ball).

In some embodiments, the highlight classifiers 260 may also analyze position of players and the ball relative to different regions on a field. For example, a sports field may be predefined into multiple zones, e.g., a goal area, a midfield, sidelines. Movement of the ball and players near the goal may indicates shooting, defending, or scoring. Passing and controlling actions often occur in the midfield. Movements toward the edges may signal out-of-bounds actions or defensive plays. Additionally, a player moving into an open space ahead of the ball may be preparing to receive a pass. Multiple players converging on the ball might indicate a contested play (e.g., a tackle or intercept). A single player moving quickly toward the goal with the ball may indicate a scoring attempt. Different types of events or sports may have different actions. The highlight classifiers 260 may be configured or trained to detect different actions for different events or sports.

The highlight generation module 270 uses the tracked movements and identified actions to create video highlights. In some embodiments, the highlight generation module 270 identifies frames that are associated with an action being performed, and label labels each frame of these frames with a corresponding action. The labels can be used to organize the video into segments for easier playback and review. For example, if the image processing module 150 identifies a downward attack in a volleyball game based on a player's jump and downward motion of hitting a ball, the highlight generation module 270 labels a subset of frames associated with the downward attack. The subset of frames starts from a moment leading up to the action until its conclusion (e.g., the ball being hit and crossing a net or being returned). The highlight generation module 270 generates a short clip or highlight based on the subset of frames.

In some embodiments, the highlight generation module 270 may combine multiple actions into a summary of a player, a summary of a team, or a summary of a game. In some embodiments, the highlight generation module automatically generate slow-motion replays of a serve or attack for detailed analysis. In some embodiments, an arrow or markings are overlayed on the relevant image frames that are part of the detected action. For example, the overlays may include a line that follows the ball's movement, and a bounding box that follows a player involved in the action. In some embodiments, the highlight generation module 270 may also add slow-motion or zoom effects during certain detected actions.

The training module 280 is configured to train the ball classifier 210, human classifier 220, other objects classifiers 230, ball tracking module 240, human tracking module 250, and highlight classifiers 260 using the training dataset 290. In some embodiments, the training module 280 performs training offline, with both the training module 280 and the training dataset 290 stored separately from the trained models 210-260 and the highlight generation module 270. In other embodiments, an additional training dataset may be created based on correctly classified objects identified by the machine learning models 210-260. The models 210-260 may then be retrained using this additional training dataset to further improve accuracy.

### Example Machine Learning Network

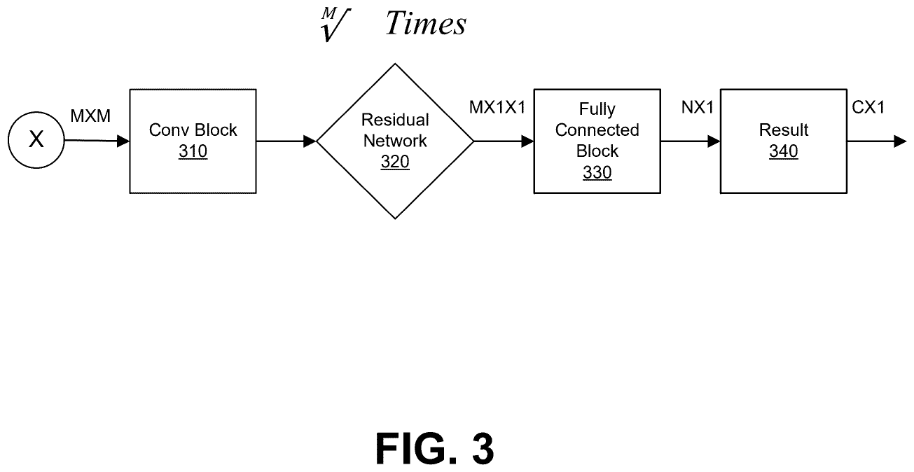

FIG. 3 illustrates an example machine learning network 300 trained to detect actions using a combination of convolutional, residual, and fully connected layers, in accordance with one or more embodiments. The network 300 includes a convolutional block 310, a residual network 320, a fully connected block 330, and a result block 340. The network 300 receives input data X. In some embodiments, the input data X may include raw video frames in a form of M×M matrix. Alternatively, the input data X may be preprocessed video frames in a form of M×M matrix. The input data X is received by the convolutional block 310. The convolutional block 310 includes multiple layers that apply a series of convolutional filters to the input data X to extract features. The features may include edges, textures, and specific object shapes, e.g., a ball or a player in motion. The output of the convolutional block 310 may be a set of feature maps that contain visual information from the input data X.

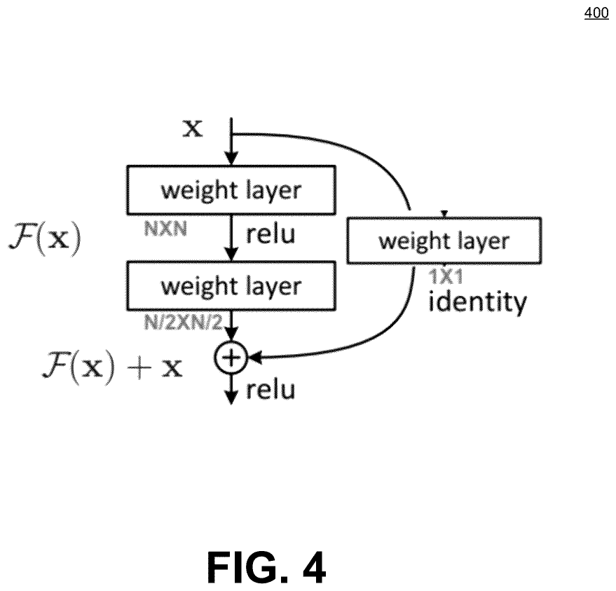

The feature maps are then input into the residual network 320. In some embodiments, the residual network 320 includes one or more residual blocks. This residual network is a deep neural network architecture that learns residuals of transformations rather than learning the entire transformation from scratch. The residual network effectively processes both the spatial and temporal dimensions of video data. In some embodiments, the residual network 320 performs temporal analysis of movement patterns across video frames and considers the context of how sequences of movements evolve over time. Additionally, the residual network 320 may perform iterative learning, progressively refining its understanding of the features. In some embodiments, the number of iterations performed by the residual network 320 is related to the dimension of the input image (M), with larger input dimensions resulting in more iterations. Additional details about the residual network are further described below with respect to FIG. 4.

The output of the residual network 320 is a M×1×1 dimensional data structure. M×1×1 dimension means the output of the residual network 320 is condensed into a single dimensional vector. The output of the residual network 320 is then input to a fully connected block 330. The fully connected block 330 is configured to aggregate the learned features from the residual network 320 and make final predictions. The fully connected block 330 may include a neural network layer, in which every neuron in the layer is connected to every neuron in a previous layer. The number of neurons may correspond to the number of elements in the single dimensional vector M. In some embodiments, M neurons are in the fully connected layer. In some embodiments, the fully connected block 330 is configured to identify actions associated with players and a ball based on the output from the residual network 320. In some embodiments, the output of the fully connected block 330 is a C×1 vector, where C represents a number of classes or categories in a classification task, or a number of output features.

For example, in the context of sports action detection, the C classes may include different types of actions or events that the network 300 is trained to recognize in a given sport (e.g., volleyball). Each class represents a distinct action or event that occurs during a game. The network 300's goal is to classify segments of a video or sequence of frames into one of these action categories. For example, in volleyball, the network 300 may be trained to detect and classify actions, such as attack, blank, pass, serve, set, among others. In soccer, the network 300 may be trained to detect actions, such as pass, dribble, shoot, tackle, goal, foul, among others. In basketball, the network 300 may be trained to detect and classify actions, such as dribble, pass, shot, steal, block, dunk, free throw, among others. In tennis, the network 300 may be trained to detect actions, such as serve, forehand, backhand, volley, smash, lob, drop shot, among others. These are merely a few example sports events. The same principles are applicable to other sports events that do not involve a ball, such as hockey and frisbee.

FIG. 4 illustrates an example architecture of a residual block 400 in accordance with one or more embodiments. As described above, the residual network 320 may include multiple residual blocks 400 to iteratively process input data, where output of a first residual block is input of a second residual block. The residual block 400 is configured to receive input data X and output data F(X)+X. As illustrated, the residual block 400 includes multiple weight layers 410, 420, 430. The first two weight layers 410, 420 on the left form a residual path, and the third weight layer 430 forms an identity mapping path. The residual block 400 uses an identity path to allow the input X to bypass a weight layers 410, 420 and be added to the output.

In some embodiments, the first weight layer 410 may be a convolutional layer with a filter size of N×N. The layer 410 is followed by a ReLu activation function to introduce non-linearity. The second weight layer may be another convolutional layer with a filter size of N/2×N/2, followed by another ReLu activation function. The third weight layer 430 is an identity mapping layer configured to allow input data X to pass through a 1×1 weight, which ensures that the dimension of the input data X matches the output from the residual path. The output from the residual path F(x) is added element-wise to the original input X from the identity path. After the element-wise addition of F(x) and x, a final ReLU activation is applied to the result to further introduce non-linearity at the output of the residual block 400.

The first and second weight layers 410, 420 are trained to learn the residual function F(X) by learning the difference between the input and the desired output, such that the network can more easily adapt and adjust the input with only minor changes. The ReLU functions are used after each weight layer to introduce non-linearity to help the residual block 400 to learn more complex functions and representations. The weight layer 430 allows the input to bypass the residual path (including weight layers 410, 420) and be added directly to the output, which ensures that even when the weight layers 410, 420's output is close to 0, the block 400 can still pass the input as output.

Further, unlike traditional residual blocks, the residual block 400 is trained via a novel loss function that is capable of support high-resolution images or videos. A loss function is used in machine learning (during the training) to measure how well a model's prediction aligns with the true data. It quantifies an error between the predicted values from the model and the actual target values (also referred to as ground truth). The goal of training is to minimize loss (computed based on the loss function), thereby improving the model's accuracy and performance.

Returning back to FIG. 2, in some embodiments, the image processing module 150 further includes a training module 280 and a training dataset 290. The training dataset 290 includes labeled image frames. The training module 280 applies the training dataset 290 to a machine learning network, e.g., the machine learning network 300 to adjust the parameters or weights of the machine learning network. The adjustment of the parameters or weights is based on a loss function that compares a prediction of the machine learning network with the training dataset 290 (i.e., ground truth). The larger the difference, the higher the loss (computed based on the loss function), which indicates poor performance by the machine learning network, thus greater adjustments of parameters or weights are performed. In neural networks, after the loss is calculated based on the loss function, the model uses backpropagation to adjust the weights and biases of the network. This adjustment is done in a way that reduces the loss in future predictions. Traditional loss functions include mean squared error, mean absolute error, cross-entropy loss, and hinge loss.

Unlike the traditional loss functions, the machine learning network 300 described herein applies a novel loss function represented below as equations 1 and 2:

$${Y}_{loss} = {exp}^{− δ} ( Y − {Y}_{hat} ) [ δ = ∞ if \sum ( Y − {Y}_{hat} ) < ϵ \qquad Equation ( 1 )$$

$$loss = \sqrt{\sum {Y}_{loss}^{2}} \qquad Equation ( 2 )$$

In Equation (1) δ is a scaling factor for controlling the sensitivity of the exponential term to differences between the true value Y and the predicted value Yₕₐₜ. The prediction Yₕₐₜ and the ground truth Y are compared element-wise. This means that instead of using the entire output vector for each sample, the loss function evaluates the discrepancy at each output position. The use of an exponential function enables the loss function to heavily penalizes large deviations, while smaller errors result in smaller penalties. The loss function also introduces an edge case. If the sum of the differences between the ground truth (Y) and the prediction (Yₕₐₜ) is smaller than a threshold ϵ, δ is set to infinity, causing Yₗₒₛₛ and the overall loss to approach zero.

In equation (2), the overall loss is computed as the square root of the sum of squared element-wise losses. This loss function is tested and proved to work well for high-resolution images and videos in action detection. The machine learning network 300 is responsible for extracting features at various levels, and the loss function ensures that even small discrepancies between the predicted and true values are captured at each level of the feature extraction process. During backpropagation, the gradient of the loss will affect how the weights in the residual block are updated. With this novel loss function, the machine learning network 300 is able to focus more on correcting large deviations that are greater than the predetermined threshold E.

For example, the network 300 is trained to detect specific actions in a high-resolution video (e.g., serve vs. spike in volleyball). Each frame of the video provides spatial and temporal features. The network 300 processes these features, and at each pass, the residual block 400 predicts refined versions of the action label. The loss function is applied to each element of the prediction. If the network makes a large error on a key feature (e.g., incorrectly identifying the player's movement as part of a “serve” rather than a “spike”), the loss function will heavily penalize this error, forcing the residual block to learn better. On the other hand, if the error is sufficiently small (e.g., a slight difference in ball trajectory prediction), the loss function will ignore such a small error.

A model trained over the above described machine learning network 300 is proven to perform well over large scale data. Table 1 below is a training report providing detailed performance metrics for an example model trained over the above described machine learning network. The training process (corresponding to the training report) completed 441 epochs, where an epoch is one full pass through the training dataset. The training speed is at about 1.11 iterations per second. The training report shows that the model has achieved perfect performance (100% accuracy) across all metrics on the training data, which suggests that the model has learned to classify each class perfectly in this specific dataset. The validation accuracy is around 81.2%, indicating that the model is performing well on the unseen validation set also.

TABLE 1

| Class | Precision | Recall | F1-Score | Support |
|---|---|---|---|---|
| attack | 1 | 1 | 1 | 1081 |
| blank | 1 | 1 | 1 | 1223 |
| pass | 1 | 1 | 1 | 1104 |
| serve | 1 | 1 | 1 | 1113 |
| set | 1 | 1 | 1 | 1063 |
| accuracy | 1 | 1 | 1 | 5584 |
| macro avg | 1 | 1 | 1 | 5584 |
| weighted | 1 | 1 | 1 | 5584 |
| avg | | | | |

In the above training report (shown in Table 1), precision is the ratio of true positive predictions to the total number of positive predictions (both true positives and false positives). In this case, precision is 1.0 across all classes, meaning that all positive predictions were correct. Recall is the ratio of true positive predictions to the total actual positives. Here, recall is also 1.00, indicating the model identified all actual positive cases correctly. F1-score is a harmonic mean of precision and recall. An F1-score of 1.00 across all classes shows a perfect balance between precision and recall. Support refers to the number of instances of each class present in the validation set. For example, there were 1081 instances of the “attack” class, 1104 instances of the “pass” class, and so on. Accuracy is 1.00, indicating that the model classified every sample correctly in this dataset. Macro average is the average of precision, recall, and F1-score across all classes, treating each class equally. Weighted average takes into account the number of instances (support) for each class, giving more weight to classes with more examples. In both cases, the values are 1.0, showing that the model performs perfectly across all classes and that there is no class imbalance affecting the performance.

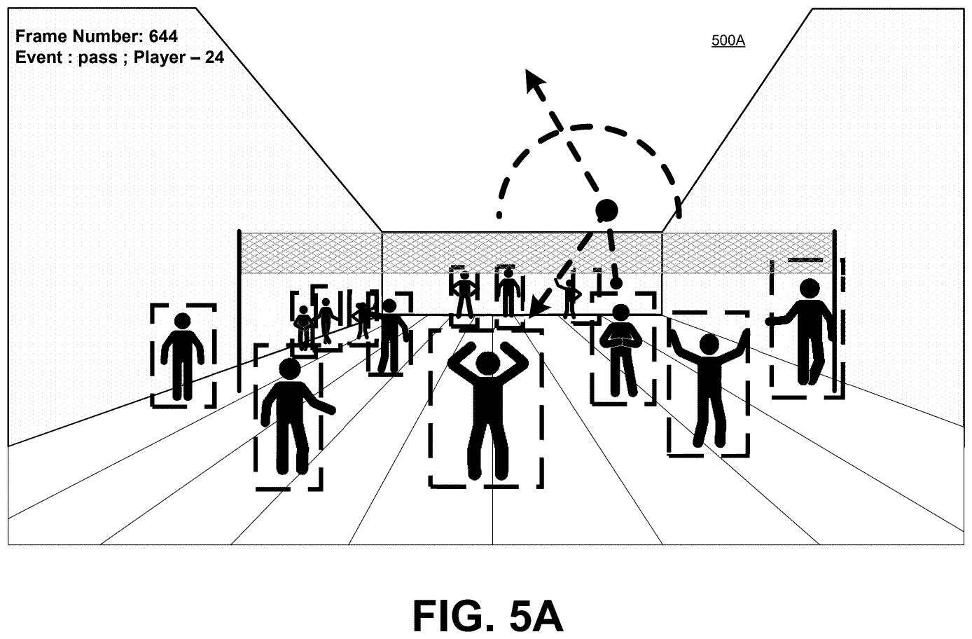

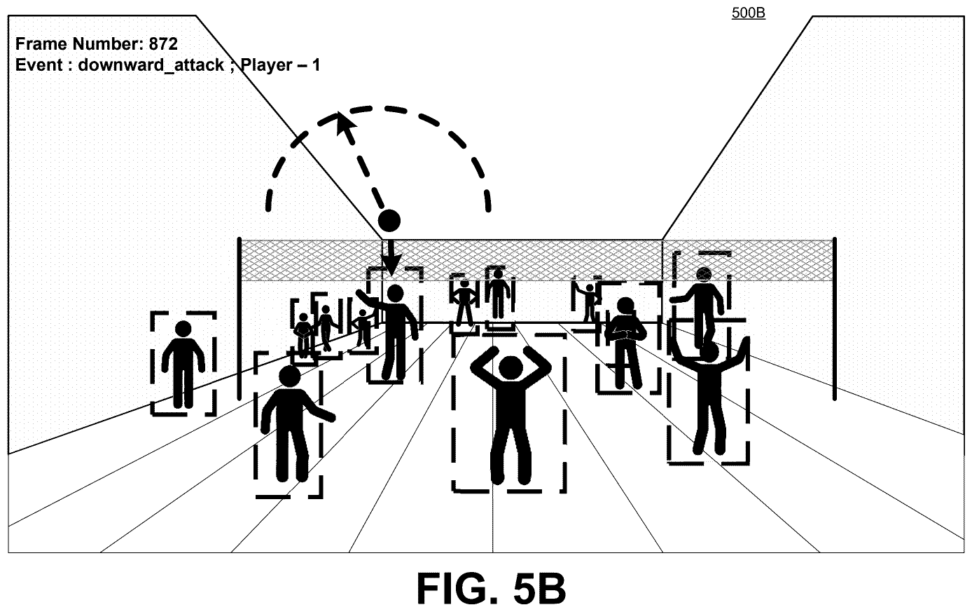

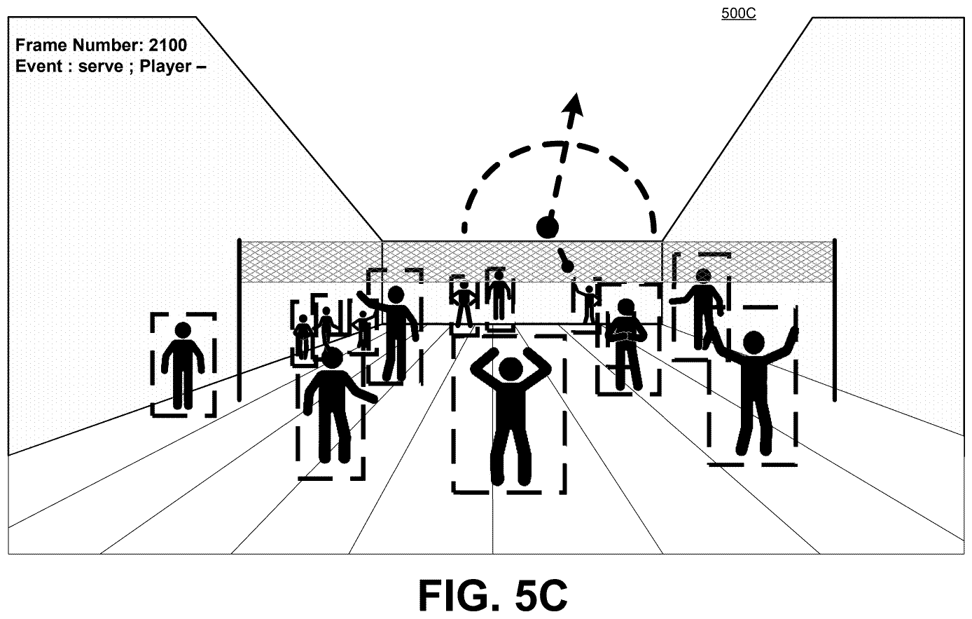

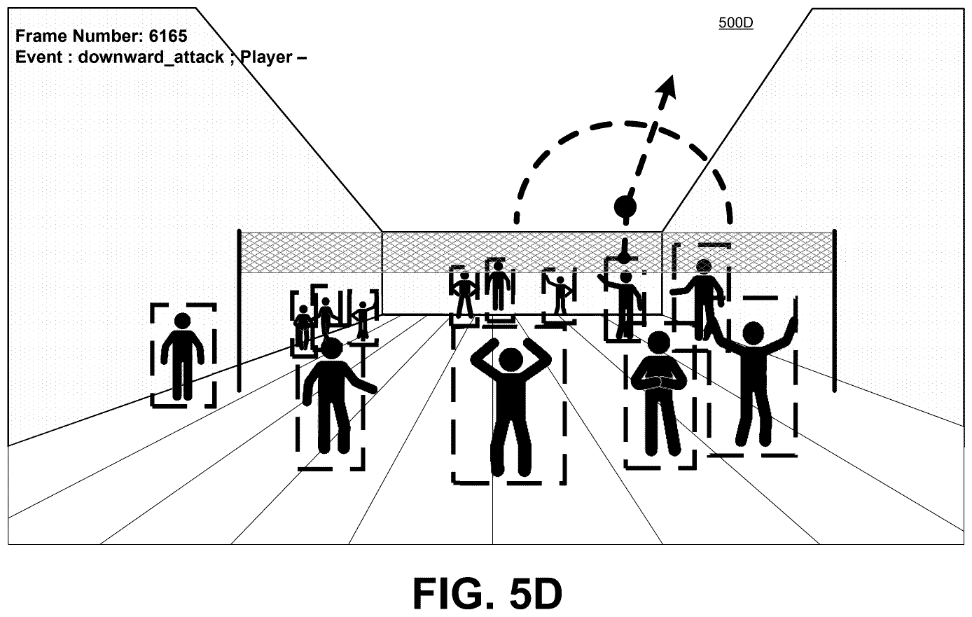

FIGS. 5A-5D illustrate examples of sports actions detection by the image processing module 150 in accordance with one or more embodiments. Each image in FIGS. 5A-5D shows a video frame where a sports action has been detected. Referring to FIG. 5A, frame number 644 represents a specific moment in the video or game being analyzed by the image processing module 150. The action detected in this frame is a pass action by Player 24. In volleyball, a pass action refers to a player receiving the ball, typically after a serve or attack, and directing it to a teammate for continued play (e.g., a set or spike). The image processing module 150 identifies Player 24 as performing the “pass” action, and this classification is displayed in the top left corner of the frame.

This action detection is based on a combination of the player's and ball's position, movement, and/or their interactions. Additionally, as shown in FIG. 5A, each player in the frame is annotated with a bounding box, generated by the human classifier 220. These bounding boxes assist the highlight classifiers 260 by focusing on the players' movements and interactions with the ball to accurately identify the action. As such, even though the video frame is high resolution, the highlight classifiers 260 only needs to process a portion of the high-resolution image, reducing the computational requirement, and increasing the processing speed.

Furthermore, Player 24, who is executing the pass, is highlighted with a label. An arrow represents the detected movement direction of the ball, showing where the ball is headed after Player 24 makes contact. The curved line serves as a visual aid, centered on the ball, creating an arc to indicate the potential area where the ball may be directed.

FIG. 5B presents another frame where a downward attack action by Player 1 is detected. In volleyball, a downward attack refers to a spike or hit aimed toward the opponent's court. Again, image processing module 150 identified this action based on the player's and ball's position, movement, and/or their interactions. As in the previous example, all players are annotated with bounding boxes, generated by the human classifier 220. These boxes help the highlight classifiers 260 track the players' positions and movements. Player 1, executing the downward attack, is specifically highlighted by the system. An arrow points downward to indicate the ball's predicted direction following the attack. A curved line, forming a semi-circle above the ball, visually represents the area where the ball might be directed. The opposing team's players are positioned defensively, preparing to receive the attack, and their movements are also tracked by the image processing module 150 using the bounding boxes. This enables the detection of potential actions these players may take once the ball crosses into their side of the court.

Depending on the camera's position, actions may be performed by players on a more distant court. The highlight classifiers 260 is capable of detecting actions from players on these distant courts as well. Notably, the actions on the further court and those on the closer court are captured from different perspectives. For example, a camera may capture players on a first court from the front, while showing the backs of players on a second court. In some embodiments, the machine learning network 300 may be trained over images of actions performed on different courts, such that the machine learning model is able to identify the same action performed by players facing the camera or by players with their back to the camera.

FIG. 5C illustrates an example of sports action detection performed by a player on a distant court. The image processing module 150 detects a serve being performed in frame 2100. In volleyball, a serve initiates the play by sending the ball over the net to the opposing team. The image processing module 150 identifies the player performing the serve, though the player's number is not identifiable. This classification, “serve,” is shown in the top left corner of the frame. Again, each player on the court is annotated with a bounding box, generated by the human classifier 220. The highlight classifiers 260 uses these bounding boxes to track players' positions and movements. The highlight classifiers 260 identifies the player performing the serve, and focuses on this player. As in the other examples, the detection is based on the player's and the ball's position and movement, as well as the interaction with the ball.

The movement direction of the ball is indicated by an arrow. Additionally, a curved line is used as a visual aid, showing the upward arc of the ball's potential range of movement. The players on the opposing team are positioned and ready to receive the serve, as indicated by their stances. The bounding boxes around these players help the highlight classifiers 260 track their positions and actions, allowing the highlight classifiers 260 to anticipate how these players will react to the serve and detect any subsequent actions they may perform after receiving the ball.

FIG. 5D illustrates another example of sports action detection performed by a player in a distant court. This frame is numbered 6165, and the image processing module 150 detects a downward attach action performed by an unknown player in a further court. Similar to previous examples, all players in the frame are annotated with bounding boxes, generated by the human classifier 220. These bounding boxes help the highlight classifiers 260 track player positions and movements on the court. The highlight classifiers 260 identifies the player performing the downward attack and highlights their actions, as shown in the middle of the image frame. Again, the ball's motion is once again indicated by an arrow, while the curved line around the ball represents the potential range of its movement.

Notably, the downward attack actions in FIG. 5B and FIG. 5D may look different due to variations in camera perspective, viewing angle, and visual details; however, the machine learning network 300 is trained to accurately recognize both actions. In FIG. 5B, the camera is closer to the action, capturing the downward attack from a near and likely rear view. This perspective allows the highlight classifiers 260 to “see” the player's full posture, including arm, leg and body movements, along with the ball's exact trajectory. On the other hand, in FIG. 5D, the camera is further away, while possibly showing a frontal view of the player performing the downward attack. This distance and different viewpoint could obscure some key details of the action, such as the precise body movement or the intensity of the hit. To ensure accurate detection across different views, the highlight classifiers 260 may use separate sets of training images for downward attacks from different perspectives. For example, one set of training images include closer, rear views like in FIG. 5B, where the details of the attack are fully visible; another set of training images can be from distance or frontal views, like in FIG. 5D, where the visual details are less prominent and different cues may be used to detect the action.

### Example Method for Sports Action Identification and Highlight Videos Generation

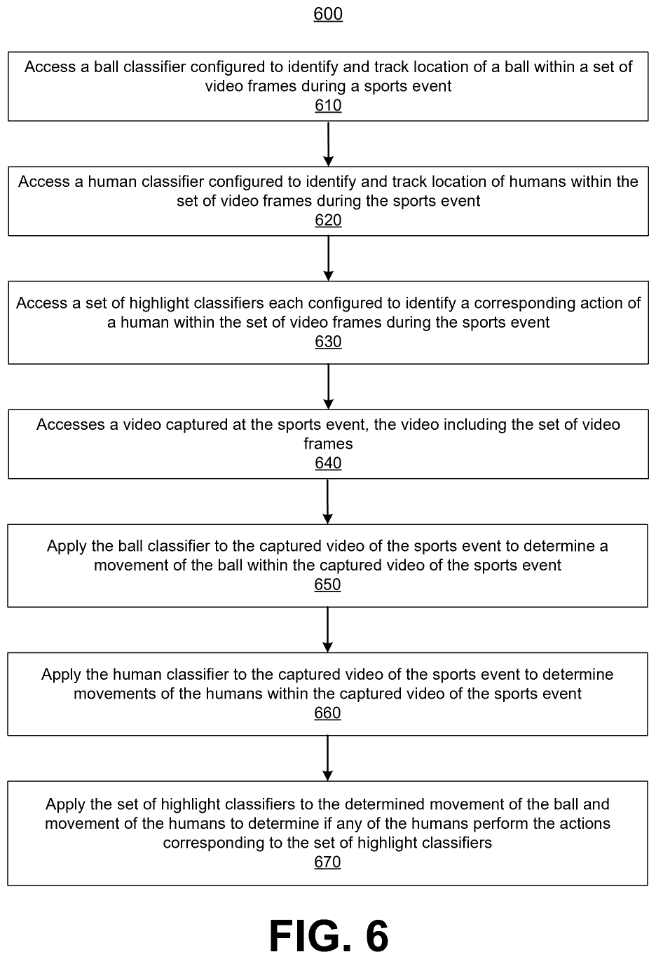

FIG. 6 illustrates a flowchart of a method 600 for sports action identification in accordance with one or more embodiments. The method 600 may be performed by an image processing module 150, which may be implemented at a server (e.g., streaming service 120) or deployed onto an edge device (e.g., an image capture device 110 or a client device 130). In some embodiments, method 600 may include additional or fewer steps than those shown in FIG. 6. The steps in method 600 can be performed in any order unless a specific step needs to be completed before another can proceed.

The image processing module 150 accesses 610 a ball classifier configured to identify and track locations of a ball within a set of video frames during a sports event. As described above with respect to FIG. 2, the ball classifier may be trained over a supervised training process using a training dataset including images labeled with or without a ball.

The image processing module 150 also accesses 620 a human classifier configured to identify and track locations of humans within the set of video frames during the sports event. Similar to the ball classifier, the human classifier may also be trained over a supervised training process using a training dataset including images labeled with or without a human. In some embodiments, the human classifier is configured to annotate each identified human with a bounding box.

The image processing module 150 also accesses 630 a set of highlight classifiers each configured to identify a corresponding action of a human within the set of video frames during the sports event. The set of highlight classifiers is trained to identify human actions by tracking the positions and movements of both the ball and the humans, as well as analyzing the interactions between them.

The image processing module 150 accesses 640 a video captured the sports event. The video includes the set of video frames. In some embodiments, the image processing module 150 is a part of an image capturing device that captures the sports event. The image processing module 150 accesses the video in real time. In some embodiments, the image processing module 150 is a part of a streaming service that receives captured images from an image capture device 110 via a network 140. In some embodiments, the image processing module 150 may be a part of the client device 130 that receives captured images from the streaming service 120 via a network 140.

The image processing module 150 applies 650 the ball classifier to the captured video of the sports event. In some embodiments, the ball classifier is applied to each video frame captured at the sports event to determine a location of the ball at times corresponding to the video frames, and tracks the locations of the ball across multiple frames to determine the movement of the ball. Similarly, the image processing module 150 applies 660 the human classifier to the captured video of the sports event. In some embodiments, the human classifier is applied to each video frame captured at the sports event to determine a location or pose of each human, and tracks the locations and poses of each human across multiple frames to determine movements of the humans. In some embodiments, the human classifier uses bounding boxes to identify humans' positions, and each identified human is annotated with a bounding box.

The image processing module 160 applies 670 the set of highlight classifiers to the determined movement of the ball and the movement of the humans to determine if any of the humans perform the actions corresponding to the set of highlight classifiers. For example, in volleyball, the set of highlight classifiers may be trained to detect attack, blank, pass, serve, set actions, among others. In soccer, the set of highlight classifiers may be trained to detect kick-off, pass, shot on goal, dribble, tackle, save, foul actions, among others. In basketball, the set of highlight classifiers may be trained to detect dribble, pass, jump shot, layup, dunk, block, rebound, steal, foul actions, among others. These are merely a few example sports events. The same principles are applicable to other sports events that do not involve a ball, such as hockey and frisbee.

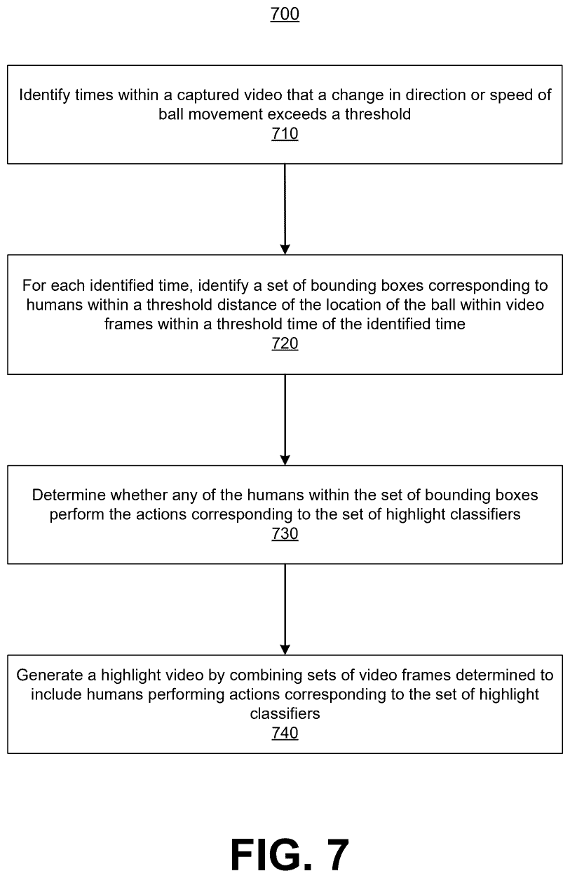

FIG. 7 is a flowchart of a method for using machine learning models to generate highlight videos in accordance with one or more embodiments. The method 700 may be performed by an image processing module 150, which may be implemented at a server (e.g., streaming service 120) or deployed onto an edge device (e.g., an image capture device 110, a client device 130). In some embodiments, method 700 may include additional or fewer steps than those shown in FIG. 7. The steps in method 700 can be performed in any order unless a specific step needs to be completed before another can proceed.

The image processing module 160 identifies 710 times within a captured video that a change in direction or speed of ball movement exceeds a threshold. For each identified time, the image processing module 160 identifies a set of bounding boxes corresponding to humans who are within a threshold distance from the ball's location in the video frames, and within a threshold time of the identified event. The image processing module 160 determines 730 whether any of the humans within the set of bounding boxes perform the actions corresponding to the set of highlight classifiers. The image processing module 160 generates a highlight video by combining sets of video frames that have been identified to include humans performing actions that match the set of highlight classifiers.

In some embodiments, the image processing module 160 may generate a highlight video including all the detected highlights during the sports event. Alternatively, or in addition, the image processing module 160 may generate a highlight video for any given team or player in one or more sports events.

In some embodiments, the automated highlight generation can be used during live sports events, identifying key plays such as goals, spies, passes, or fouls. Real-time detection of key moments can enhance fan experiences by providing instant replays or in game statistics. The highlights can also assist referees in identifying fouls, out-of-bounds actions, or other rule violations. Alternatively, or in addition, coaches and analysts can track players' actions and movement patterns, such as successful attacks, defensive plays, or positioning, for deeper insights into performance.

The above descriptions are mostly directed to identifying actions performed by players during a sports event. However, the similar principles described herein can be applied to a wide range of industries and use cases where real-time and post-analysis of human, machine, and/or object interactions are involved. For example, in autonomous driving, action detection can be used to track and analyze the movements of pedestrians, cyclists, and vehicles to predict behaviors and ensure safe navigation. Action detection can also help identify traffic signals, stop signs, and other road markers, adjusting the vehicle's response accordingly. As another example, in surveillance and security systems, action detection can identify suspicious or unusual behavior, such as loitering, running, or unauthorized access, enabling faster response to security threats. In public spaces, the technology can also be used to detect actions like fights, stampedes, or other emergency situations that require immediate intervention. In healthcare and rehabilitation settings, action detection can be used to monitor patients' movements and detect falls, improper posture, or physical therapy exercises. In retail, action detection can be used to analyze shopper behaviors, such as time spent looking at products, paths taken through stores or interactions with sales staff, to improve store layout or marketing strategies, and/or theft prevention.

### Example Computing System

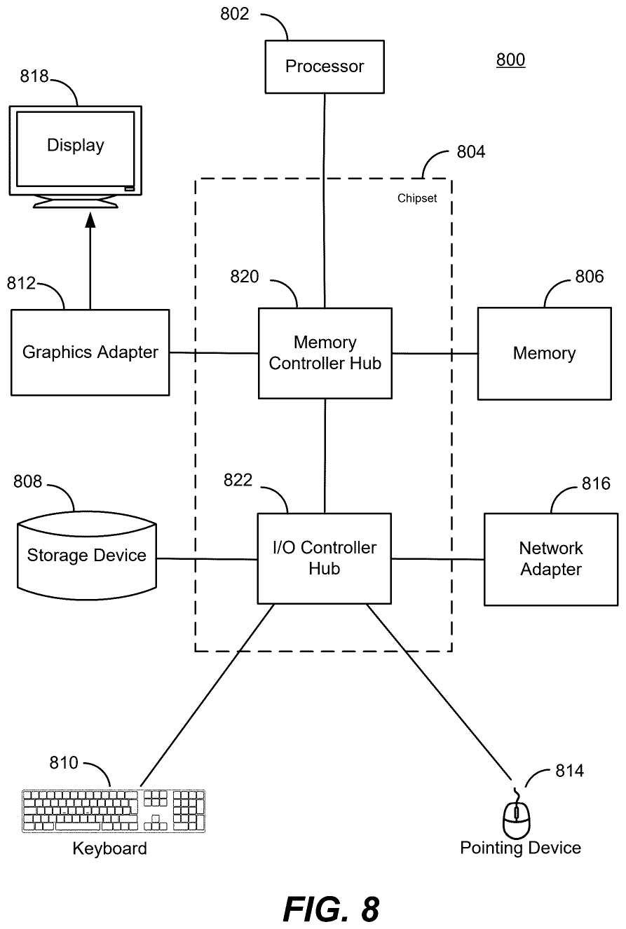

FIG. 8 is a block diagram of an example computer 800 suitable for use in the networked computing environment 100 of FIG. 1. The computer 800 is a computer system and is configured to perform specific functions as described herein. For example, the specific functions corresponding to image processing module 150 may be configured through the computer 800.

The example computer 800 includes a processor system having one or more processors 802 coupled to a chipset 804. The chipset 804 includes a memory controller hub 820 and an input/output (I/O) controller hub 822. A memory system having one or more memories 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other types of a pointing device and may be used in combination with the keyboard 810 (which may be an on-screen keyboard) to input data into the computer 800. The graphics adapter 812 displays images and other information on the display 818. The network adapter 816 couples the computer 800 to one or more computer networks, such as network 140.

The types of computers used by various entities of FIG. 1 can vary depending upon the embodiment and the processing power required by the entities. For example, the streaming service 120 might include multiple blade servers working together to provide the functionality described. Furthermore, the computers can lack some of the components described above, such as keyboards 810, graphics adapters 812, and displays 818.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising one or more computer-readable media containing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed:

1. A method comprising:
accessing a ball classifier configured to identify a location within a video frame of a ball and to track the location of the ball as the ball moves within a set of video frames during a sports event;
accessing a human classifier configured to generate bounding boxes around humans within the set of video frames during the sports event;
accessing a set of highlight classifiers each configured to identify a corresponding action of a human within the set of video frames of the sports event;
capturing a video of the sports event, the video including the set of video frames;
applying the ball classifier to the captured video of the sports event to determine a movement of the ball within the captured video of the sports event;
applying the human classifier to generate bounding boxes around humans within the captured video of the sports event;
identifying, based on the determined movement of the ball, times within the captured video that a change in direction or speed of ball movement exceeds a threshold;
for each identified time, identifying a set of bounding boxes within a threshold distance of the location of the ball within video frames and within a threshold time of the identified time and applying the set of highlight classifiers to the identified set of bounding boxes to determine if any of the humans within the bounding boxes perform the actions corresponding to the set of highlight classifiers; and
generating a highlight video by combining sets of video frames determined to include humans performing actions corresponding to the set of highlight classifiers.

2. The method of claim 1, wherein determining the movement of the ball includes recording positions of the ball as two-dimensional coordinates in each video frame and generating a time series of two-dimensional ball positions.

3. The method of claim 1, wherein determining the movement of the ball includes recording positions of the ball as three-dimensional coordinates in each video frame and generating a time series of three-dimensional ball positions.

4. The method of claim 1, wherein the ball classifier is further configured to determine a movement vector of the ball based on changes in positions of the ball between consecutive video frames.

5. The method of claim 1, wherein the human classifier is further trained to identify a plurality of joints on a body of a human and determine a pose of the human based on positions of the plurality of joints, and the set of highlight classifiers determines an action performed by a human further based on the pose of the human.

6. The method of claim 1, wherein the human classifier is further trained to differentiate team members based on uniform colors or numbers on uniforms.

7. The method of claim 1, wherein the set of highlight classifiers are trained to identify actions specific to a given sport, and the actions include at least one of passing and serving.

8. The method of claim 1, wherein the set of highlight classifiers is a machine learning model including a residual network, wherein the residual network is trained via a loss function based on per element loss.

9. The method of claim 8, wherein the loss function also includes an exponential term, when an error is smaller than a predetermined threshold, an exponent of the exponential term approaches infinity, causing loss to approach 0.

10. The method of claim 8, wherein the residual network interactively applies a plurality of residual blocks;
each residual block including a residual path and an identity path;
the residual path includes a plurality of convolutional layers configured to output residual feature map; and
output of the convolutional path and output of the identity path are combined together to generate output of the residual block.

11. A non-transitory computer readable medium having instructions encoded thereon that, when executed by one or more processors, cause the one or more processors to perform steps comprising:
accessing a ball classifier configured to identify a location within a video frame of a ball and to track the location of the ball as the ball moves within a set of video frames during a sports event;
accessing a human classifier configured to generate bounding boxes around humans within the set of video frames during the sports event;
accessing a set of highlight classifiers each configured to identify a corresponding action of a human within the set of video frames of the sports event;
capturing a video of the sports event, the video including the set of video frames;
applying the ball classifier to the captured video of the sports event to determine a movement of the ball within the captured video of the sports event;
applying the human classifier to generate bounding boxes around humans within the captured video of the sports event;
identifying, based on the determined movement of the ball, times within the captured video that a change in direction or speed of ball movement exceeds a threshold;
for each identified time, identifying a set of bounding boxes within a threshold distance of the location of the ball within video frames and within a threshold time of the identified time and applying the set of highlight classifiers to the identified set of bounding boxes to determine if any of the humans within the bounding boxes perform the actions corresponding to the set of highlight classifiers; and
generating a highlight video by combining sets of video frames determined to include humans performing actions corresponding to the set of highlight classifiers.

12. The non-transitory computer readable medium of claim 11, wherein determining the movement of the ball includes recording positions of the ball as two-dimensional coordinates in each video frame and generating a time series of ball positions.

13. The non-transitory computer readable medium of claim 11, wherein determining the movement of the ball includes recording positions of the ball as three-dimensional coordinates in each video frame and generating a time series of ball positions.

14. The non-transitory computer readable medium of claim 11, wherein the ball classifier is further configured to determine a movement vector of the ball based on changes in positions of the ball between consecutive video frames.

15. The non-transitory computer readable medium of claim 11, wherein the human classifier is further trained to identify a plurality of joints on a body of a human and determine a pose of the human based on positions of the plurality of joints, and the set of highlight classifiers determines an action performed by a human further based on the pose of the human.

16. The non-transitory computer readable medium of claim 11, wherein the human classifier is further trained to differentiate team members based on uniform colors or numbers on uniforms.

17. The non-transitory computer readable medium of claim 11, wherein the set of highlight classifiers are trained to identify actions specific to a given sport, and the actions include at least one of passing and serving.

18. The non-transitory computer readable medium of claim 11, wherein the set of highlight classifiers is a machine learning model including a residual network, wherein the residual network is trained via a loss function based on per element loss.

19. The non-transitory computer readable medium of claim 18, wherein the loss function also includes an exponential term, when an error is smaller than a predetermined threshold, an exponent of the exponential term approaches infinity, causing loss to approach 0.

20. A computing system, comprising:
one or more processors; and
a non-transitory computer readable medium having instructions encoded thereon that, when executed by one or more processors, cause the one or more processors to perform steps comprising:
accessing a ball classifier configured to identify a location within a video frame of a ball and to track the location of the ball as the ball moves within a set of video frames during a sports event;
accessing a human classifier configured to generate bounding boxes around humans within the set of video frames during the sports event;
accessing a set of highlight classifiers each configured to identify a corresponding action of a human within the set of video frames of the sports event;
capturing a video of the sports event, the video including the set of video frames;
applying the ball classifier to the captured video of the sports event to determine a movement of the ball within the captured video of the sports event;
applying the human classifier to generate bounding boxes around humans within the captured video of the sports event;
identifying, based on the determined movement of the ball, times within the captured video that a change in direction or speed of ball movement exceeds a threshold;
for each identified time, identifying a set of bounding boxes within a threshold distance of the location of the ball within video frames and within a threshold time of the identified time and applying the set of highlight classifiers to the identified set of bounding boxes to determine if any of the humans within the bounding boxes perform the actions corresponding to the set of highlight classifiers; and
generating a highlight video by combining sets of video frames determined to include humans performing actions corresponding to the set of highlight classifiers.
